(19) United States
(12) Patent Application Publication
(10) Pub. No.: US 2003/0156193 A1
(43) Pub. Date: Aug. 21, 2003

(54) Vehichle-mounted video switching device

(76) Inventor: Yoshiyuki Nakamura, Tokyo (JP)

Correspondence Address: Jay H Maioli, Cooper & Dunham, 1185 Avenue of the Americas, New York, NY, 10036, US

(21) Appl. No.: 10/240,157

(22) PCT Filed: Jan. 29, 2002
(86) PCT No.: PCT/JP02/00665

(30) Foreign Application Priority Data
Jan. 30, 2001 (JP) P2001-022233

(51) Int. Cl. H04N 7/18; H04N 9/47

(52) U.S. Cl. 348/148

(57) ABSTRACT

A video switching apparatus for automobile use which is mounted on a vehicle equipped with a video display device includes a storage element which stores therein a remote control signal received by the video display device or a video appliance connected to the video display device for input switching; a detection element which detects a predetermined driving state signal of the vehicle; and a transmission element which, when the detection means has detected the predetermined driving state signal, transmits a remote control signal stored in the storage means.

### TECHNICAL FIELD

The present invention relates to an in-vehicle video switching apparatus which is mounted on, for example, an automobile and is suitable for use in connecting video cameras for monitoring the rear and side of the automobile to a video display device mounted on the automobile.

### BACKGROUND ART

Recently various kinds of so-called “back monitors” have been in practical use, in which a video camera is attached to the rear of a vehicle such as an automobile to display an image picked-up by the video camera on a monitor installed at a predetermined position within the vehicle. This back monitor is used, mainly when a driver makes his vehicle go back, to improve safety by confirming the safety at the rear of an automobile, which is a blind spot to the driver. With respect to the monitor, in a large-sized vehicle such as a truck or a bus in which the safety at the rear thereof is difficult to be confirmed with the driver's own eyes, usually a display device exclusively used for back-monitoring is attached adjacent to the driver's seat.

There have also been cases where a monitor connected to an apparatus so-called “car navigation apparatus” for displaying a road map showing the current driving position, etc. is used as the display device for back-monitoring only when confirming the safety at the rear is needed. Using the display device for the navigation apparatus as the display device for back-monitoring requires no additional display device exclusively used for back-monitoring and, therefore, the system configuration can be simplified.

However, in order to use a display device for a conventional navigation apparatus as a back-monitoring device, on the navigation apparatus side the display device requires to be set as the back-monitoring device. Accordingly, any display device for a navigation apparatus which is not set as described above had the difficulty in being used as the back-monitoring device.

Specifically, in order to use the display device as a back-monitoring device, the following measures are needed. The navigation apparatus requires a single-purpose video input terminal for connecting the back-monitoring video camera and an input terminal for a back position signal. Further, it is arranged to detect within the navigation apparatus the back position signal in conjunction with the operation of a shift lever for making the automobile go back and to display the back-monitoring video on the display device only during the time in which the back position signal is “on”. Namely, in other state (i.e., during the ordinary driving), a video for navigation is displayed by the display device.

In the case where the navigation apparatus does not have the above-described measures for back-monitoring, it is difficult to automatically perform switching the display video in conjunction with the going-back operation of the vehicle. Therefore, the user (driver) needs to manually input operation to switch the displayed video, however since such switching operation is irrelevant to the driving operation itself, it is not preferable for the driver. Accordingly, when attaching a back monitor to the vehicle having mounted therein the navigation apparatus without back-monitoring measures, it was necessary to attach a back-monitoring display device separate from the display device for the navigation apparatus, and these respective display devices perform their respective displaying operations independently. However, providing two display devices in this way is inefficient.

### DISCLOSURE OF THE INVENTION

In view of the above-described respects, the object of the present invention is to favorably perform back-monitoring operation or the like, by connecting a video camera to an existing navigation apparatus which has been mounted on a vehicle.

A first aspect of the present invention is a video switching apparatus for automobile use being mounted on a vehicle equipped with a video display device, comprising: storage means for storing therein a remote control signal received by the video display device or a video appliance connected to the video display device for input switching; detection means for detecting a predetermined driving state signal of the vehicle; and transmission means for transmitting the remote control signal stored in the storage means, when the detection means has detected the driving state signal.

According to the above-described configuration, when this video switching apparatus has detected a predetermined driving state signal of the vehicle, a remote control signal which causes the video display device or the video appliance connected to this video display device to perform input switching is transmitted, thereby automatically switching the video displayed on the video display device to a specific input video. Consequently, by providing this video switching apparatus, it becomes possible to control the input switching using, for example, a generally usable navigation apparatus equipped with an external video input terminal such that the video being displayed on the display device of the navigation apparatus is switched to the video picked-up by the back-monitoring video camera only when the vehicle is in a specific state of driving.

A second aspect of the present invention is the video switching apparatus for automobile use according to the first aspect of the present invention, in which even when the detection means has ceased to detect the driving state signal, the transmission means transmits the remote control signal stored in the storage means.

According to the above-described configuration, it becomes possible to perform input switching control, such as returning the display on the display device of the navigation apparatus from the display for back-monitoring to the original display.

A third aspect of the present invention is the video switching apparatus for automobile use according to the first aspect of the present invention, further comprising reception means for receiving the remote control signal, in which the remote control signal received by the reception means, in a state where a predetermined operation mode is set, is stored in the storage means.

According to the above-described configuration, by receiving, for example, the infrared ray signal transmitted by the remote control device of the navigation apparatus to be stored in the storage means, it becomes possible to cause appliances using any type of input switching remote control signal to reliably perform input switching operation.

A fourth aspect of the present invention is the video switching apparatus for automobile use according to the first aspect of present invention, further comprising: a plurality of video signal input units, an input switching unit for selecting one video signal from among the video signals obtained at the plurality of video signal input units, and control means for controlling the input selection in the input switching unit, in which the control means causes the input switching unit to select the video signal obtained at a specific video signal input unit when the detection means has detected the driving state signal.

According to the above-described configuration, with the system construction having connected thereto a number of video signal sources, it becomes possible to select the video from a specific video signal source when the vehicle is in a specific state of driving. For example, when only one external video input terminal is provided for the navigation apparatus, it has been arranged that the video switching apparatus according to the present invention is connected to the external video input terminal to supply the video signal selected by the video switching apparatus. As a result, when a specific driving state has been detected, a specific video signal selected by the video switching apparatus is supplied to the navigation apparatus side and, on this navigation apparatus side as well, the specific video signal is selected to be displayed. When the vehicle is in a driving state other than the specific one, other video signals supplied to the video switching apparatus is selected by a key operation or the like to be displayed on the navigation apparatus side.

A fifth aspect of the present invention is the video switching apparatus for automobile use according to the fourth aspect of the present invention, in which the detection means detects a first and second driving state signals as the driving state signals; when the detection means has detected the first driving state signal, the transmission means transmits the remote control signal stored in the storage means, and the control means causes the input switching unit to select a first video signal input unit; and when the detection means has detected the second driving state signal, the transmission means transmits the remote control signal stored in the storage means, and the control means causes the input switching unit to select a second video signal input unit.

According to the above-described configuration, it becomes possible to perform input switching operations corresponding to a plurality of driving states. For example, it becomes possible to perform a switching operation to select the video from a back-monitoring video camera or the video from a side-monitoring video camera according to a driving state which requires monitoring by the respective video camera.

A sixth aspect of the present invention is the video switching apparatus for automobile use according to the first aspect of the present invention, further comprising power supply means for supplying power to an outside video camera, in which when the detection means has detected the driving state signal, the power is supplied to the connected video camera to start monitoring.

According to the above-described configuration, it is also possible to control the monitoring by the video camera by controlling the power supply in conjunction with the input switching operation. Accordingly, when performing the monitoring by connecting a video camera to the navigation apparatus, or the like, the control of the operation of the video camera can be excellently performed in conjunction with the input switching.

### BRIEF DESCRIPTION OF THE DRAWINGS

FIG. 1 is a block diagram illustrating an example of the system construction according to an embodiment of the present invention;

FIG. 2 is a perspective view illustrating an example in which the system according to an embodiment of the present invention is mounted on a vehicle;

FIG. 3 is a flow chart illustrating an example of the learning operation according to an embodiment of the present invention;

FIG. 4 is a flow chart illustrating an example of the operation of the input switching device according to an embodiment of the present invention; and

FIGS. 5A, 5B, 5C, 5D, and 5E are timing charts illustrating an example of the operation timing according to an embodiment of the present invention.

### BEST MODE FOR CARRYING OUT THE INVENTION

An embodiment of the present invention has a system construction in which the so-called back-monitoring video camera for monitoring the rear of an automobile and the so-called side-monitoring video camera for monitoring the side of the automobile are installed within the automobile having mounted thereon a navigation apparatus displaying a video such as a road map, etc., to guide the automobile, and the videos taken by those cameras are displayed on a display device for the navigation apparatus.

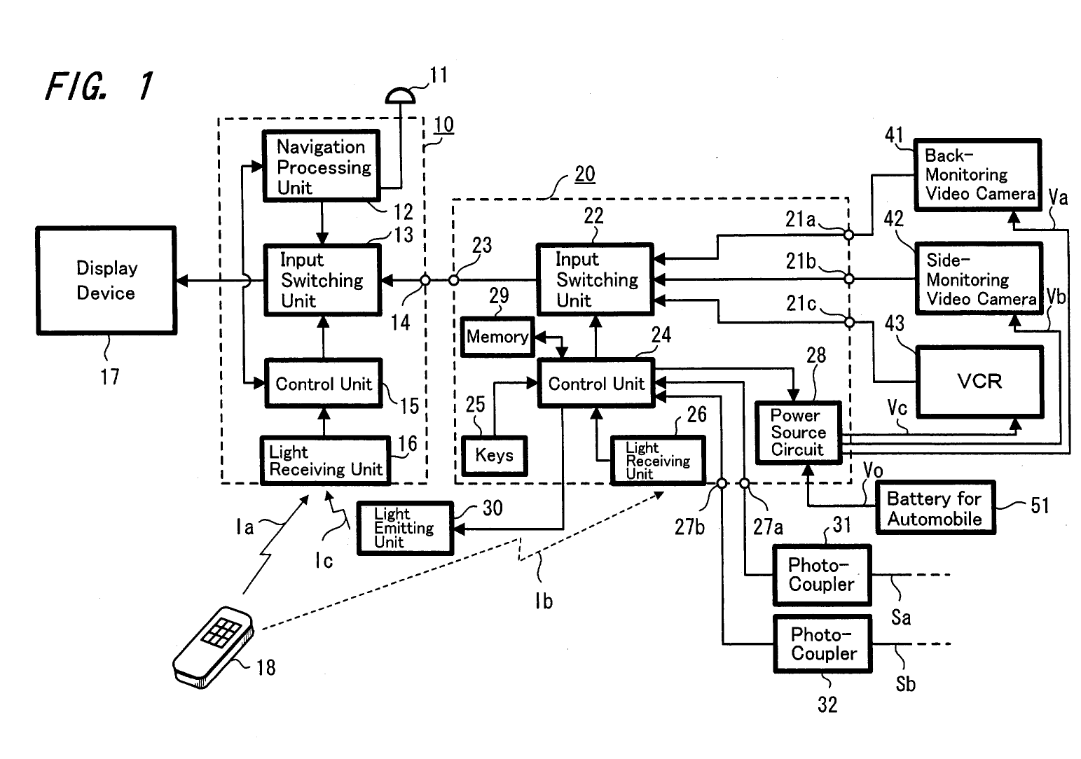

FIG. 1 is a block diagram illustrating the entire system construction of this embodiment mounted on an automobile. In this system construction, an antenna 11 which receives a position-measuring signal such as a GPS (Global Positioning System) is connected to a navigation device 10; in a navigation processing unit 12, measurement of the current position is performed based on the measurement signal; and a navigation video such as a road map showing areas adjacent to the measured current position is produced based on the information from a database such as a built-in optical disk. Then, a video signal for displaying the navigation video such as the road map is supplied through an input switching unit 13 to a display device 17 which is connected to this navigation device 10 to display the video.

The navigation device 10 according to this embodiment further includes an external video input terminal 14 to supply a video signal obtained at this input terminal 14 to the input switching unit 13. Further, it is arranged that based on the control by a control unit 15 a desired signal between the navigation video signal and the video signal obtained at the external input terminal 14 is selected in the input switching unit 13, and the selected signal is supplied to the display device 17. The control unit 15 also performs control on the navigation processing in the navigation processing unit 12. The control operation in the control unit 15 is performed according to a remote control signal received by a light-receiving unit 16.

Specifically, the navigation device 10 according to this embodiment is configured to perform the operation control by means of a remote control signal which is transmitted as an infrared ray signal Ia from a remote control device 18 exclusively provided for the operation of the navigation device 10. The input switching operation in the input switching unit 13 is controlled by transmitting an input switching command from the remote control device 18 as well. In the remote control device 18, there are provided input selection keys, in addition to various keys necessary for the navigation operation, for causing the input switching unit 13 to select a video obtained at the external input terminal 14 and for causing the input switching unit 13 to select a video for the navigation. It is arranged that a remote control signal serving as the corresponding input switching command (these commands are hereinafter called “the external video selection command” and “the navigation video selection command”) is transmitted when the respective input selection key is pressed.

The display device 17 may be a video display device using a liquid crystal display, for example, and the device is disposed in the vicinity of the driver's seat in an automobile where the driver's forward view is not hindered.

An input switching device 20 according to this embodiment is connected to the external video input terminal 14 of the above-described navigation device 10. In the input switching device 20 according to this embodiment, there are provided three video signal input terminals 21a, 21b, and 21c, whereby the video signals obtained at the respective input terminals 21a, 21b, and 21c are supplied to an input switching unit 22. In this embodiment, a video signal output by a back-monitoring video camera 41 is supplied to the input terminal 21a, a video signal output by a side-monitoring video camera 42 is supplied to the input terminal 21b, and a video signal output by a video cassette recorder (VCR) 43 is supplied to the input terminal 21c.

In the input switching unit 22, one video signal from among the signals obtained at the three input terminals is selected based on the control by a control unit 24 to be output from a video output terminal 23. In this embodiment, the video signal obtained at this video output terminal 23 is supplied to the external video input terminal 14 of the navigation device 10.

Further, in this embodiment, keys 25 are connected to the control unit 24 in the input switching device 20. By operating these keys 25, it is possible to manually select a desired input from among the input at three terminals. Also, a light receiving unit 26 is connected to the control unit 24 to supply a waveform pattern of the infrared ray signal received by this light receiving unit 26 to the control unit 24. When a predetermined mode (a later described learning mode) is set, the control unit 24 causes the received waveform pattern of the infrared ray signal to be stored in a memory 29 which is connected to the control unit 24. As the memory 29, for example, a nonvolatile rewritable memory is used. When the later described learning mode is set, there is performed processing of storing the signal pattern of the infrared ray signal Ib transmitted from the remote control device 18 exclusively used for the navigation device 10 in this memory.

Further, the input switching device 20 according to this embodiment includes a input terminal, to which a driving state signal is supplied from a circuit in the driving control system of the automobile, etc. Namely, the input switching device 20 comprises a back position signal input terminal 27a and a direction indication signal input terminal 27b. There is supplied a back position signal of a high level to the back position signal input terminal 27a when the automobile's shift lever is changed to the backward position. There is supplied a direction indication signal of a high level to the direction indication signal input terminal 27b when the driver has operated the automobile's direction indicator to indicate a predetermined direction (in this embodiment the left direction) and flickered the direction indicator corresponding to the predetermined direction. The states of respective signals supplied to these input terminals 27a and 27b are determined by the control unit 24.

In this embodiment, the back position signal and direction indication signal supplied from the circuit in the driving control system of the automobile, etc., are supplied to the input terminals 27a and 27b through photocouplers 31 and 32 which detect the flow of respective signals by photo-sensors so that the circuit in the driving control system of the automobile, etc., and the input switching device 20 are electrically separated. By detecting the respective signals in the state where the circuit and the input switching device 20 are electrically separated, it is possible to prevent noises from entering into the input switching device 20 from the circuit in the driving control system of the automobile. In FIG. 1, although the photo-couplers 31 and 32 are provided outside the input switching device 20, it may be configured such that the signals obtained at the terminals 27a and 27b are detected through the photo-couplers 31 and 32 within the input switching device 20; and these detected signals are supplied to the control unit 24.

The control unit 24 automatically controls the input switching in the input switching unit 22 based on the states of the respective signals supplied to the input terminals 27a and 27b. In this embodiment, a light emitting unit 30 lead out to the outside of the input switching device 20 is connected to the device 20 by means of a cable, whereby the infrared ray signal Ic can be transmitted from the light emitting unit 30 according to the control of the control unit 24. The infrared ray signal transmitted from this light emitting unit 30 is an infrared ray signal having a pattern stored in the memory 29, and the transmission timing thereof is set based on the state of the respective signals supplied to the input terminals 27a, 27b. The control processing of the control unit 24 based on the signals supplied to the input terminals 27a, 27b will be explained in detail when later explaining the relevant operation.

Further, the input switching device 20 according to this embodiment includes a power source circuit 28 which supplies power to the video signal sources (video cameras 41, 42 and a VCR 43) connected to the input terminals 21a, 21b, and 21c of this input switching device 20. As the power source circuit 28, there is provided an automobile battery 51 mounted on the automobile, which supplies a power source V0 such as a direct current voltage 12V. Within the power source circuit 28, step-down processing of the supplied power source V0 , or the like, is performed to produce a power Va which is supplied to the back-monitoring video camera 41, a power Vb which is supplied to the side-monitoring video camera 42, and a power Vc which is supplied to the VCR 43. Regarding the supply of the power Va, Vb, and Vc to the respective appliances 41, 42, and 43 from the power source circuit 28, it is arranged that the supply can be individually controlled according to the instructions from the control unit 24.

Specifically, the power Va is supplied to the video camera 41 while a video signal supplied from the video camera 41 to the input terminal 21a is being selected within the input switching unit 22; and the power Vb is supplied to the video camera 42 while a video signal supplied from the video camera 42 to the input terminal 21b is being selected within the unit 22. It is arranged that the respective video cameras 41, 42 perform monitoring during the time in which the power is being supplied to output a video signal. Regarding the VCR 43, the power Vc is constantly supplied thereto. With respect to the on/off operation of the power source for the VCR 43, it is set by operating the power source key provided for the VCR, which is not illustrated in the FIG. 1, and it is configured that the power source for the VCR is not controlled within the input switching device 20.

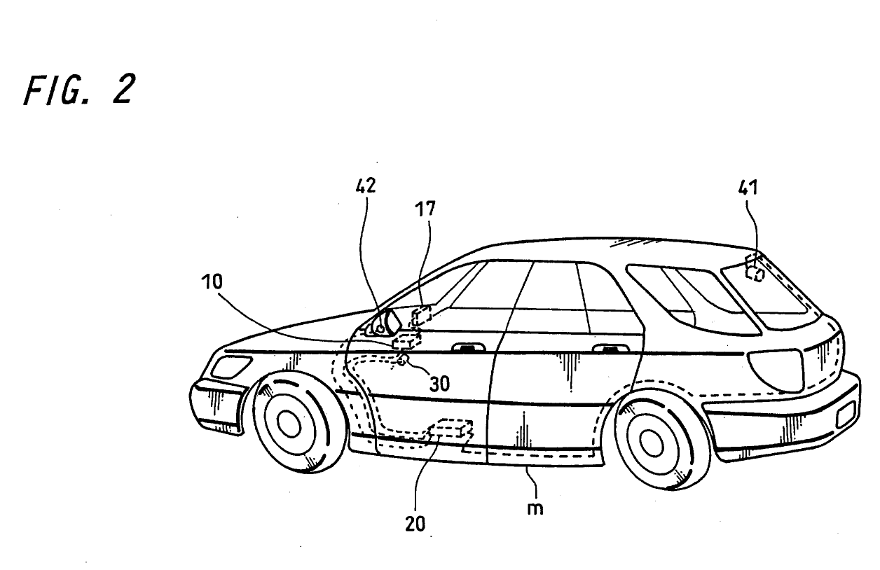

FIG. 2 is a view illustrating an example in which the system of this embodiment is mounted on an automobile. Within the automobile m, there is installed the navigation device 10 and the display device 17 which is disposed on a dash board, or the like, located in front of the driver's seat of the automobile m. The input switching device 20 is installed in the space under the seat, or the like. This input switching device 20 is connected to the navigation device 10, and the light emitting unit 30 lead out from the input switching device 20 is disposed in the vicinity of the light receiving unit 16 of the navigation device 10. Further, on the rear end of the automobile m, there is mounted the back-monitoring video camera 41, while, to the left side door mirror, there is attached the side-monitoring video camera 42. The respective video output terminals of the video cameras 41, 42 are connected to input terminals of the input switching device 20.

As shown in FIG. 2, the side-monitoring video camera 42 is attached to the left side door mirror when an automobile has its driver's seat located on the right side, and the side-monitoring video camera 42 is attached to the right side door mirror if an automobile has the driver's seat located on the left side. When the video taken by the back-monitoring video camera 41 is displayed on the display device 17, this video is generally displayed as the so-called “mirror reversed image” which is obtained by inverting the left and the right of the original video. The processing of producing the mirror reversed image may be executed in any of the circuits within the video camera 41, the navigation device 10, the input switching device 20, and the display device 17. Further, regarding the video taken by the side-monitoring video camera 42, correction processing or other may be necessary in some cases.

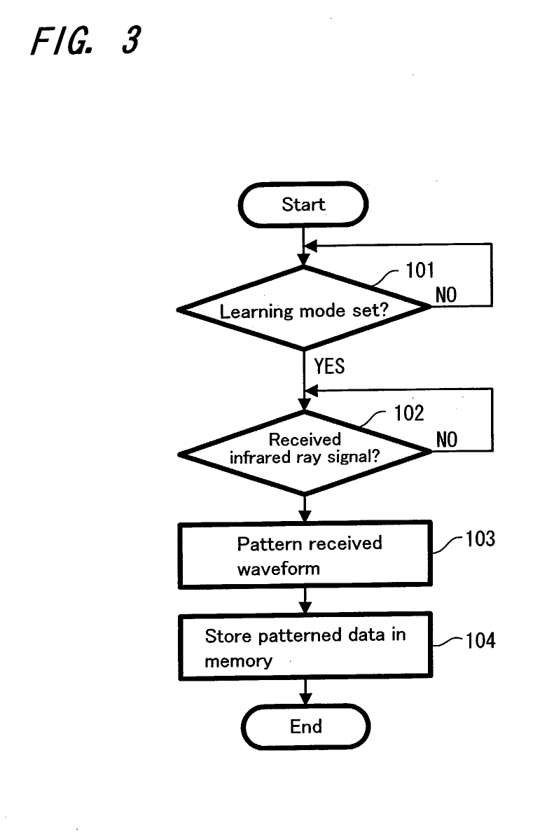

With the above-described system construction, an example of the operation in which switching the video using the input switching device 20 is performed will be explained. First, the input switching device 20 requires initial setting for learning the remote control signal transmitted from the remote control device 18 which used for the navigation device 10. FIG. 3 is a flow chart illustrating an example of this learning operation. The learning operation is executed through the control performed by the control unit 24 in the video switching device 20. The control unit 24 determines whether the learning mode has been set by operating the key 25 or otherwise (step 101). When it has been determined that the learning mode has been set, the control unit 24 determines whether the light receiving unit 26 has received an infrared ray signal (step 102). The control unit 24 waits until the light receiving unit receives an infrared ray signal.

At this time, the user, who performs initial setting, brings a light emitting portion of the remote control device 18 close to the light receiving unit 26 in the video switching device 20, and then presses an input switching key disposed on the remote control device 18 to switch the input to the external input, thereby transmitting a remote control signal for switching to an external input.

On the input switching device 20 side, when having received, as described above, the transmitted infrared ray signal in step 102, the light receiving unit 26 performs wave-forming and patterning the wave form of the received infrared ray signal to transmit the signal pattern data to the control unit 24 (step 103). The control unit 24 causes this signal pattern data to be stored in a memory area for storing the remote control signal in the memory 29 (step 104). At this time, when other commands previously stored are being stored in the memory area, these stored data are updated by replacing the data with the new data.

As already described in the configuration of FIG. 1, as the input switching commands transmitted from the remote control device 18, there are at least two kinds of commands: one of which is the external video selection command and the other of which is the navigation video selection command. In the processing illustrated in the flow chart of FIG. 3, these two kinds of commands need to be stored in the memory. In this case, as the setting of the learning mode in the step 101, for example, two kinds of setting: one of which is the setting of the learning mode for the external video selection command, and the other of which is the setting of the learning mode for the navigation video selection command are provided, and a pattern of a remote control signal corresponding to each learning mode is stored. In a case where the external video selection command and the navigation video selection command are the same command, storage operation needs to be performed only once. In the following explanation, the external video selection command and the navigation video selection command are considered to be separate commands.

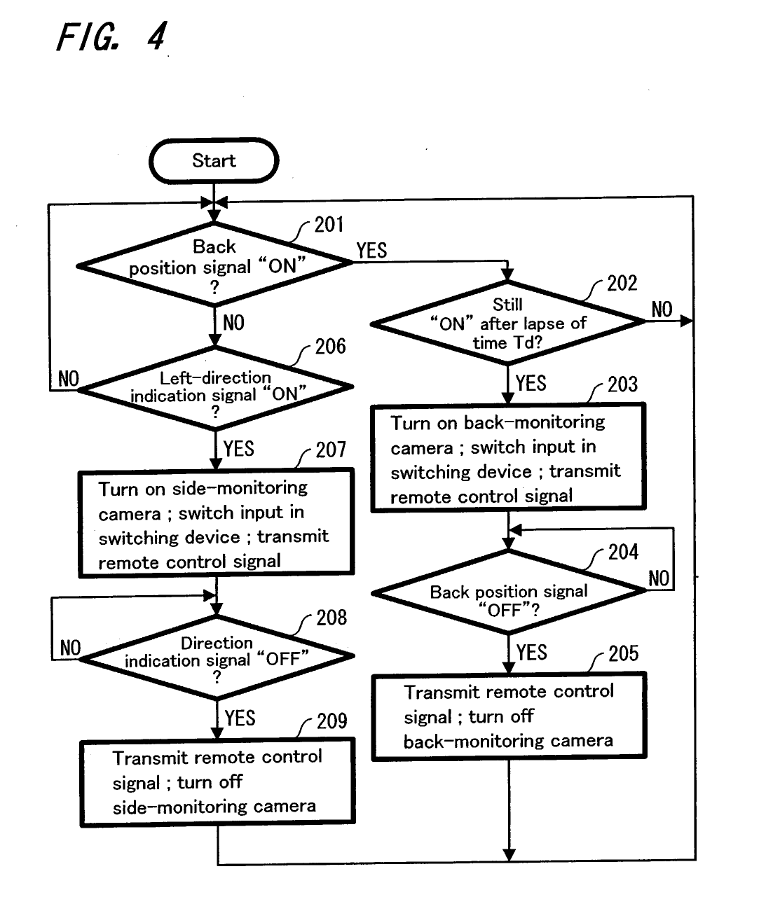

Referring to the flow chart in FIG. 4, the input switching operation performed by the control unit 24 will be explained, in which the commands are previously stored in the input switching device 20 as described above. First, the control unit 24 determines whether the back position signal obtained at the input terminal 27a has become “on” (a high level) (step 201). When it is determined that the back position signal has been changed to an “on” state, the control unit 24 determines whether the “on” state continues during the time td set as the dead band after becoming the “on” state (step 202). When the back position signal has ceased to be “on” (namely has returned to the low level) during the dead-band time td, the control unit 24 judges that the “on” state was caused by a temporary operation of the shift lever. As a result, the flow returns to the step 201. It is to be noted that the dead band time td is assumed to be a relatively short time such as approximately one second.

When in the step 202 it has been determined that the back position signal is kept in the “on” state while the dead-band time td elapses, the control unit 24 performs processing of causing the back-monitoring video camera 41 to start monitoring and causing the display device 17 to display the video signal output from the video camera 41 (step 203). Specifically, the power Va is supplied from the power source circuit 28 in the input switching device 20 to the video camera 41 to start the operation of monitoring, and the video signal obtained at the input terminal 21a is selected in the input switching unit 22 within the input switching device 20 to be output from the output terminal 23. Further, the control unit 24 reads out the pattern of the external video selection command stored in the memory 29 and causes the infrared ray signal of that pattern to be transmitted from the light emitting unit 30.

Upon transmission of this infrared ray signal from the light emitting unit 30, the signal is received by the light receiving unit 16 in the navigation device 10, thereby performing the input switching operation in which the control unit 15 causes the input switching unit 13 to select the video signal obtained at the external video input terminal 14 as a video signal for display. As a result, the video signal taken and output by the video camera 41 is supplied to the display device 17, thereby displaying the back-monitoring video.

In the control unit 24 within the input switching device 20, it is determined whether the back position signal obtained at the input terminal 27a has become “off” state (low level) after the processing in the step 203 has been executed (step 204). When having not changed to an “off” state, the control unit 24 waits as it is. When in the step 204, it has been determined that the back position signal has changed to an “off” state, the control unit executes processing of returning the video displayed on the display device 17 to the original video and suspending the operation of monitoring by the video camera 41 (step 205). Specifically, the control unit 24 reads out the pattern of the navigation video selection command stored in the memory 29 to transmit the infrared ray signal having the pattern from the light emitting unit 30. Also, the control unit 24 stops the supply of the power Va from the power source circuit 28 in the input switching device 20 to the video camera 41 to suspend the operation of monitoring by the video camera 41. Upon completion of the processing in the step 205, the control unit 24 returns to the step 201.

Further, when the control unit 24 has judged that the back position signal has not changed to the “on” state in the step 201, whether the left side direction indication signal has become “on” is determined (step 206). When it is judged that the left side direction indication signal does not change into the “on” state, the control unit 24 returns to the step 201.

When the control unit 24 judges that the left side direction indication signal has changed to the “on” state in the step 206, the control unit executes processing of causing the side-monitoring video camera 42a to start monitoring and also causing the display device 17a to display the video signal output from the video camera 42 (step 207). Specifically, the power Vb is supplied from the power source circuit 28 in the input switching device 20 to the side-monitoring video camera 42 and the control unit causes the video camera 42 to start the operation of monitoring and causes the input switching unit 22 in the input switching device 20 to select the video signal obtained at the input terminal 21b to output the video signal from the output terminal 23. Further, the control unit reads out the pattern of the external video selection command stored in the memory 29 and transmits the infrared ray signal of the corresponding pattern from the light emitting unit 30.

Upon transmission of the infrared ray signal from the light emitting unit 30, the signal is received by the light receiving unit 16 in the navigation device 10, thereby performing the input switching operation in which the control unit 15 causes the input switching unit 13 to select the video signal obtained at the external video input terminal 14 as the video signal for display. As a result, the side-monitoring video signal taken and output by the video camera 42 is supplied to the display device 17 to be displayed.

In the control unit 24 within the input switching device 20, it is determined whether the left side direction indication signal obtained at the input terminal 27b has become the “off” state (low level) after the processing in the step 207 has been executed (step 208). When having not changed to the “off” state, the control unit waits as is. When in the step 208, it has been determined that the direction indication signal has changed to the “off” state, the control unit executes processing of returning the video displayed on the display device 17 to the original video and suspending the operation of monitoring by the video camera 42 (step 209). Specifically, the control unit 24 reads out the pattern of the navigation video selection command stored in the memory 29 to transmit the infrared ray signal having the corresponding pattern from the light emitting unit 30. Also, the control unit 24 stops the supply of the power Vb from the power source circuit 28 in the input switching device 20 to the video camera 42, thereby causing the video camera 42 to suspend the operation of monitoring. Upon completion of the processing in the step 209, the control unit 24 returns to the step 201.

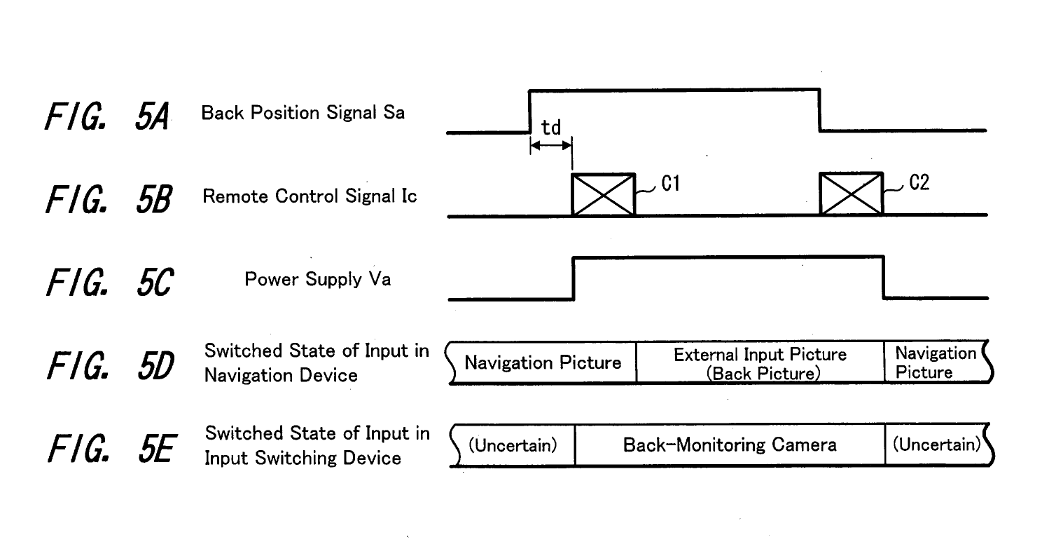

FIGS. 5A to 5E are timing charts illustrating the timing in which the back position signal Sa supplied to the input switching device 20 has changed to perform the video switching operation. FIG. 5A illustrates the state of the back position signal Sa. It is now assumed that, at a certain timing, the shift lever has been operated to change a position to make the automobile go back and as a result the back position signal Sa has changed from a low level to a high level. When this change in the level of the back position signal Sa occurs, the external video selection command C1 is transmitted by means of a remote control signal Ic transmitted as the infrared ray signal after the dead band time td elapsed, as illustrated in FIG. 5B. Simultaneously, as illustrated in FIG. 5C, the power Va starts being supplied to the video camera 41 (the power Va is being supplied during the high-level period of FIG. 5C), and the video signal from the video camera 41 is selected in the input switching unit 22 within the input switching device 20.

On the navigation device 10 side, as illustrated in FIG. 5D, the navigation video has been selected to be displayed on the display device 17 until the external video selection command C1 is received and discriminated. Then, at the time when the command C1 has been discriminated, the video signal from the video camera 41 obtained at the external video input terminal 14 is selected as the video to be displayed, thereby displaying the back-monitoring video on the display device 17.

It is assumed that time has elapsed with this state continuing for a while and, as illustrated in FIG. 5A, the back position signal Sa has returned to the low level. When the level of this back position signal Sa has changed into the low level, the navigation video selection command C2 is, as illustrated in FIG. 5B, transmitted by means of the remote control signal Ic transmitted as an infrared ray signal. After the transmission of this command C2 is completed, the supply of the power Va to the video camera 41 is stopped as illustrated in FIG. 5C. In the input switching unit 22 within the input switching device 20, a video other than that from the video camera 41 is selected as necessity occurs.

On the navigation device 10 side which has received the navigation video selection command C2, the display video on the display device 17 is switched to the navigation video, when having received and discriminated the navigation video selection command C2 as illustrated in FIG. 5D, thereby displaying the navigation video such as a road map on the display device 17.

By performing the above-described input switching operation, the following advantages are obtained. Specifically, in conjunction with the driver's operation of changing the position of the shift lever for the backward, the video displayed on the display device 17 in the navigation device 10 automatically becomes the back-monitoring video, thereby excellent monitoring of the rear of an automobile being performed without, for example, manually selecting the input video. Similarly, in conjunction with the operation of the direction indicator, the video displayed on the display device 17 in the navigation device 10 becomes the side-monitoring video, thereby excellent monitoring of the side of an automobile being performed. In this embodiment, the navigation device 10 only requires to be the device including the external video input terminal 14. Consequently, only providing the input switching device 20 in addition to the video cameras 41, 42, enables automatic switching, and excellent monitoring of the rear or side is performed even when the conventional navigation apparatus without input switching functions for monitoring the rear or side of the automobiles used. Particularly, since the input switching device 20 is provided with a learning function for storing a remote control signal, a navigation device controlled by whatever type of a remote control signal can be dealt with the input switching device 20. Therefore, the input switching device 20 has a high versatility.

Although in the above-described embodiment the external video input terminal 14 is provided in the navigation device 10 and it is arranged that switching between the video signal obtained at the input terminal 14 and the navigation video signal produced within the navigation device 10 is controlled by the remote control signal from the input switching device 20, the present invention can be also applied to the case where selection of the input is performed on the display device side.

Specifically, by providing, for example, an external video input terminal for the display device 17 connected to the navigation device 10, it is arranged that the video displayed on this display device 17 can be selected from among the video supplied from the navigation device 10 and a desired one of the videos obtained at the external video input terminal by the remote control signal received by a remote control signal receiving unit provided in the display device 17. With the above described configuration, the video signal output from the output terminal 23 of the input switching device 20 is supplied to the external video input terminal of the display device 17 and the remote control signal from the light emitting unit 30 is received by the light receiving unit in the display device 17, thereby enabling the same control as that in the above-described embodiment.

Although, in the above-described input switching device 20 according to this embodiment, the remote control signal for executing the input switching operation in the navigation device 10 is stored in the internal memory 29 through the learning processing illustrated in FIG. 3, the following configuration may also be adopted. Namely, a plurality of remote control signals for controlling the navigation device are stored in advance in the memory 29 within the input switching device 20, and then the type of the connected navigation device is selected through the key operation, etc. by the user to use the remote control signal corresponding to this selected navigation device for the control operation. In such configuration, the input switching device 20 does not require the light receiving unit 26 and, as a result, the construction can be simplified to the extent. Further, the initial setting operation can be performed in a simple way through the performance of the key operation.

Further, although in the above-described embodiment the input switching unit for selecting one video signal from a plurality of video signals is provided in the input switching device 20 and it is arranged that the video signal selected by this input switching unit is supplied to the navigation device 10, the construction for performing the input switching operation in the input switching device 20 may be omitted when the video signal source supplying the video signal to the external video input terminal 14 of the navigation device 10 is one in number. Namely, it may be arranged that the video signal from, for example, the back-monitoring video camera 41 is supplied directly to the external video input terminal 14 of the navigation device 10.

Also, in a case where a plurality of external video input terminals are provided for the navigation device 10, for example, the back-monitoring video camera 41 and the side-monitoring video camera 42 may be connected to the plurality of external video input terminals. When the back position signal has been detected by the input switching device 20, a remote control signal for selecting the input terminal to which the back-monitoring video camera 41 is connected may be transmitted. On the other hand, when the direction indication signal has been detected by the input switching device 20, a remote control signal for selecting the input terminal to which the side-monitoring video camera 42 is connected may be transmitted.

Further, although in the above-described embodiment the input switching of the video to be displayed is performed such that the navigation video and the video transmitted from the video camera, etc. are simply switched to each other between both the videos, the following construction may be adopted. Namely, the switching between a mode of displaying a navigation video on the entire screen of the display device and a mode of displaying a video from the back-monitoring video camera on a part of the displayed navigation video may be performed based on the remote control signal from the input switching device 20. In the case, for example, where the construction illustrated in FIG. 1 is adopted, the above-described configuration is possible with the function of synthesizing the navigation video and the video from the external input terminal 14 in the input switching unit 13 within the navigation device 10.

Further, although in the above-described embodiment an infrared ray signal is transmitted as the wireless remote control signal, other radio signals such as electric waves may be used.

Further, although with respect to the side-monitoring camera it is provided on one of the sides (the left side in the example of FIG. 2) of an automobile, it may be arranged that by providing the camera on each side: the left and right, a video from the corresponding side-monitoring camera may be selected through operating the respective direction indicators.

Further, in the above-described embodiment it has been arranged that the back-monitoring video camera is selected when the back position signal has been supplied and the side-monitoring video camera is selected when the direction indication signal has been supplied. However, when the back position signal and the direction indication signal have simultaneously been supplied, the video camera can be selected, for example, according to the predetermined order of priority. For example, with the back-monitoring video camera being set higher in the order of priority, it may be controlled that the video from the back-monitoring video camera is displayed when both the back position signal and the direction indication signal have been simultaneously supplied. In the above-described configuration, the following convenience is obtained. Namely, for example, when the driver keeps his automobile parking on the side of a road while he keeps the direction indicator flickering and attempts to make his automobile slightly go back, the displaying operation becomes as follows. Until stopping the automobile at the side of the road, there is displayed the video of the side which is taken by the side-monitoring video camera, whereas, when the driver operated the shift lever to make the automobile go back, the display is switched to the video of the rear which is taken by the back-monitoring video camera to be displayed.

Furthermore, in the above-described embodiment an explanation in which the back-monitoring camera and side-monitoring camera are connected to the navigation device for an automobile is described. However, the present invention can also be applied to the case where video cameras used for other purposes are connected to the vehicle and input switching is performed corresponding to the driving state.

Industrial Applicability

As described above, according to the video signal switching apparatus for automobile use of the present invention, when having detected a predetermined driving state signal of an automobile, a remote control signal for causing the video display device or the video appliance connected thereto to perform the input switching is transmitted, thereby automatically switching a video displayed on the video display device to a specific input video. Accordingly, by providing this video switching apparatus, when, for example, a generally available navigation device including an external video input terminal is used to display video, controlling the input switching operation in which the displayed video on the display device is switched to the video taken by the back-monitoring video camera only when the vehicle is in a specific driving state can be realized.

Description of Reference Numerals

10 . . . NAVIGATION DEVICE

11 . . . ANTENNA

12 . . . NAVIGATION PROCESSING UNIT

13 . . . INPUT SWITCHING UNIT

14 . . . EXTERNAL VIDEO INPUT TERMINAL

15 . . . CONTROL UNIT

16 . . . LIGHT RECEIVING UNIT

17 . . . DISPLAY DEVICE

18 . . . REMOTE CONTROL DEVICE

20 . . . INPUT SWITCHING DEVICE

21a, 21b, 21c . . . VIDEO INPUT TERMINAL

22 . . . INPUT SWITCHING UNIT

23 . . . VIDEO OUTPUT TERMINAL

24 . . . CONTROL UNIT

25 . . . KEY

26 . . . LIGHT RECEIVING UNIT

27a . . . BACKPOSITION SIGNAL INPUT TERMINAL

27b . . . DIRECTION INDICATION SIGNAL INPUT TERMINAL

28 . . . POWER SOURCE CIRCUIT

29 . . . MEMORY

30 . . . LIGHT EMITTING UNIT

31, 32 . . . PHOTO-COUPLERS

41 . . . BACK-MONITORING VIDEO CAMERA

42 . . . SIDE-MONITORING VIDEO CAMERA

43 . . . VIDEO CASSETTE RECORDER (VCR)

51 . . . BATTERY FOR AUTOMOBILE

m . . . AUTOMOBILE

Ia, Ib, Ic . . . INFRARED RAY SIGNAL

Sa . . . BACK POSITION SIGNAL

Sb . . . DIRECTION INDICATION SIGNAL

V0, Va, Vb, Vc . . . POWER

1. A video switching apparatus for automobile use being mounted on a vehicle equipped with a video display device, comprising:
storage means for storing a remote control signal received by said video display device or a video appliance connected to said video display device for input switching;
detection means for detecting a predetermined driving state signal of said vehicle; and
transmission means for transmitting the remote control signal stored in said storage means when said detection means has detected said driving state signal.

2. The video switching apparatus for automobile use according to claim 1, wherein
said transmission means transmits the remote control signal stored in said storage means even when said detection means has ceased to detect said driving state signal.

3. The video switching apparatus for automobile use according to claim 1, further comprising:
reception means for receiving the remote control signal, wherein
the remote control signal received by said reception means in a state of a predetermined operation mode being set is stored into said storage means.

4. The video switching apparatus for automobile use according to claim 1, further comprising:
a plurality of video signal input units;
an input switching unit for selecting one of the video signals obtained at said plurality of video signal input units; and
control means for controlling the selection of input in said input switching unit, wherein
said control means selects the video signal obtained at a specific video signal input unit in said input switching unit when said detection means has detected said driving state signal.

5. The video switching apparatus for automobile use according to claim 4, wherein
a first and second driving state signals are detected by said detection means as the driving state signals;
said transmission means transmits the remote control signal stored in said storage means and said control means causes said input switching unit to select a first video signal input unit when said first driving state signal has been detected by said detection means; and
said transmission means transmits the remote control signal stored in said storage means and said control means causes said input switching unit to select a second video signal input unit when said second driving state signal has been detected by said detection means.

6. The video switching apparatus for automobile use according to claim 1, further comprising:
power supply means for supplying power to an outside video camera, wherein
power is supplied to the video camera connected to said power supply means to start monitoring by the video camera when said detection means has detected said driving state signal.
